(19) United States
(12) Patent Application Publication
(10) Pub. No.: US 2017/0142911 A1
(43) Pub. Date: May 25, 2017

(54) ABOVE GROUND GARDENING SYSTEMS AND METHODS

(71) Applicants: James C. McKee, Newark, DE (US); Colleen E. McKee, Newark, DE (US)

(72) Inventors: James C. McKee, Newark, DE (US); Colleen E. McKee, Newark, DE (US)

(21) Appl. No.: 15/354,625

(22) Filed: Nov. 17, 2016

Related U.S. Application Data
(60) Provisional application No. 62/257,528, filed on Nov. 19, 2015.

(51) Int. Cl. A01G 9/02; A01G 27/00; A01G 9/26; A01G 17/02; A01G 9/24

(52) U.S. Cl. CPC A01G 9/022; A01G 17/02; A01G 9/247; A01G 9/243; A01G 9/26; A01G 27/008

(57) ABSTRACT

An above ground garden system and method utilizing: (i) a garden bed structure that is consistently sloped, curved inwardly toward the bottom of the bed (e.g, barrel shaped) which facilitates uniform water and air flow to the lowest region of the bed and avoids corners that will otherwise isolate regions of soil from aeration, water flow, and general gardening accessibility; (ii) a simple stand to elevate the entire bed of the garden off of a ground surface, particularly a single leg or pole stand that increases accessibility, and minimizes obstruction, to the area below the bed (e.g., easier mower access to lawn surface below bed); (iii) a curved trellis loop system that is designed for easy installation and utilization as vertical supports for climbing plants, which are stronger and more durable because each end of the loop system is secured to the bed or an attachment thereto, and which system does not occupy space within the soil of the garden bed nor require soil penetration or compaction in order to provide strength and support; (iv) detachable components within the trellis loop system so that a winter solar cap may be utilized over a base portion of the trellis loop system to allow for gardening beyond peak growing seasons.

### CROSS-REFERENCE TO RELATED APPLICATIONS

This application claims the benefit under 35 USC 119 of provisional application No. 62/257,528 filed Nov. 19, 2015.

### BACKGROUND OF THE INVENTION

1. Field of the Invention

The present invention relates generally to gardening systems and methods, and more particularly, to garden systems and methods in which a special purpose garden bed rests on a stand, elevated above ground level, so that a gardening activities may be performed with less need for bending, weeding, or digging, as is typically required in conventional gardening.

2. Description of Related Art

There is no admission that the background art disclosed in this section legally constitutes prior art.

U.S. Pat. No. 5,400,544 (the “Wien Patent”) describes a raised garden bed and notes that gardens that include a garden bed having a portion raised above ground level are well known in the art of gardening. Gardens with raised garden beds generally include wooden boards. However, a number of problems are associated with the use of wooden boards with raised garden beds. Wooden boards are susceptible to: (i) internal damage such as caused by wood rot and termites; and (ii) splinters. The Wien Patent attempts to solve these problems by teaching the use of plastic boards to construct a raised garden bed.

The Wien Patent also attempts to teach an aerated bed design that allows for avoidance of conventional methods of aeration, which would otherwise require the labor of turning the soil over or tilling. The Wien Patent further notes that many crops that are grown in gardens require vertical supports for supporting climbing plants. To supply vertical supports, one often provides sticks or twigs which are not easily supported in the soil. Sticks and twigs that are often used to provide vertical supports for climbing plants are often unattractive to look at and present a highly irregular and unsightly visual appearance. Wien teaches the use of a stake member that maybe driven into the soil bed inside the garden on one end, and on the other end can function as a vertical riser portion that supports a horizontal foliage support member. The stake member of the Wein Patent does not appear to provide any structural support for the base of the garden bed itself, but rather merely seems to function as a source for vertical growth support. While the garden taught by the Wien Patent may be separated and isolated from the ground surface by virtue of the disclosed garden frame, it does not teach a garden elevated on a stand several feet above a ground surface so that gardening access and activities may be accomplished more easily.

U.S. Pat. No. 7,424,787 (the “Singer Patent”) describes a garden bed assembly and method and kit thereof. The Singer Patent teaches raised garden bed planter box for containing suitable planting soil or other growing media. The Singer Patent teaches a U-shaped, fenced in garden enclosure, not a bed elevated on a single stand, let alone an elevated system design to minimize obstruction of, or to maximize access to, the area below the elevated garden. To the contrary, the boxed design and fencing taught by Singer are said to help protect the plants from unwanted pests from eating the plants.

U.S. Pat. No. 7,966,766 (the “Vogler et al. Patent”) cites the Wien Patent and further describes a raised garden bed kit and notes that the materials used in the prior art to construct raised plant beds is insufficient for simple and easy bed construction. Most notably, the Vogler et al. Patent is critical of environmentally harmful and heavy construction materials and teaches the use of polymeric kit of panel wall materials constructed to be packed into a small profile for shipping and transport and that may be snapped together for easier assembly into a walled garden enclosure or frame that may sit directly on the ground surface. Again, Vogler et al fails to teach an elevated stand that may raise the entire garden bed off the ground, i.e., where the structure of the garden bed itself is not directly supported by the ground surface.

U.S. Pat. No. 8,839,552 (the “Hudson Patent”) describes a raised garden bed system including a sprinkler system, and the like. The Hudson Patent describes an easily shipped and assembled raised garden system constructed of light weight, environmentally friendly materials. Hudson further teaches a trellis system that may function as an attachment location to facilitate for vertical growth within the garden. The Hudson system illustrated in the figures does not include an elevated stand, but instead a garden box frame the will sit directly on a flat surface. Moreover, the trellis of Hudson are not designed to be connected at the upper regions, thus limited the availability of vertical support locations and the strength of the overall trellis system.

Thus, while the foregoing body of prior art indicates it to be well known to use a series of wooden or plastic boards to construct a square or rectangular framed raised garden bed that will sit directly upon a flat surface or be raised only by a support structure (Singer) of equal to or larger than the raised beds themselves, the prior art described above does not teach or suggest a raised garden bed apparatus which has the following combination of desirable features: (1) a consistently sloped curved bottom of the bed that facilitates uniform water and air flow to the lowest region of the bed and avoids corners that will otherwise isolate regions of soil from aeration, water flow, and general gardening accessibility; (2) a simple stand to elevate the entire bed of the garden off of a ground surface, particularly a single leg or pole stand that increases accessibility, and minimizes obstruction, to the area below the bed (e.g., easier mower access to lawn surface below bed); (3) a curved trellis loop system that is designed for easy installation and utilization as vertical supports for climbing plants, which are stronger and more durable because each end of the loop system is secured to the bed or an attachment thereto, and which system does not occupy space within the soil of the garden bed nor require soil penetration or compaction in order to provide strength and support; and (4) detachable components within the trellis loop system so that a winter solar cap may be utilized over a base portion of the trellis loop system to allow for gardening beyond peak growing seasons.

### SUMMARY OF THE INVENTION

It would be desirable to have a simple, economical means of providing a curved and raised garden bed (e.g., split 55 gallon barrel in half length-wise), wherein the elevation and consistent sloping of the curved garden makes for easier access by gardener (e.g., less bending, kneeling for gardener and allows garden to access all parts of soil without trapping soil in corners) and wherein the curvature directs and facilitates water flow through soil and to the bottom of the bottom.

It would also be desirable for the elevated garden bed to utilize a single stand pole or pipe so as to minimize obstructions to the surface below which, for example, allows for easier lawn maintenance around and below the system.

It is further desired for an elevated garden system to utilize an arched gardening trellis system, in which the ends of the loops or arms on either end of the bed are attached to the bed so as to provide a stronger and more stable support for upward garden growth. Finally it is further desired for an elevated garden system to include detachable or removable components within the trellis system so that a winter solar cap may be installed over a base portion of the trellis loop system in order to extend the garden's utility beyond peak growing seasons.

### BRIEF DESCRIPTION OF THE DRAWINGS

FIG. 1 is a graphic depiction of a preferred embodiment of the above ground gardening system.

FIG. 2 is a graphic depiction of success steps that may be employed to constructed an above ground gardening system according to a preferred embodiment, as illustrated in FIG. 1.

FIG. 3 is a graphic depiction, in two views (3A & 3B) of an alternative trellis loop system in a preferred embodiment of the above ground gardening system.

FIG. 4 is a graphic depiction of an alternative loop, bed, and stand systems in a preferred embodiment of the above ground gardening system.

### DEFINITIONS

While mostly familiar to those versed in the art, the following definition is provided in the interest of clarity.

[defined term]: [definition]

### DETAILED DESCRIPTION OF PREFERRED EMBODIMENTS

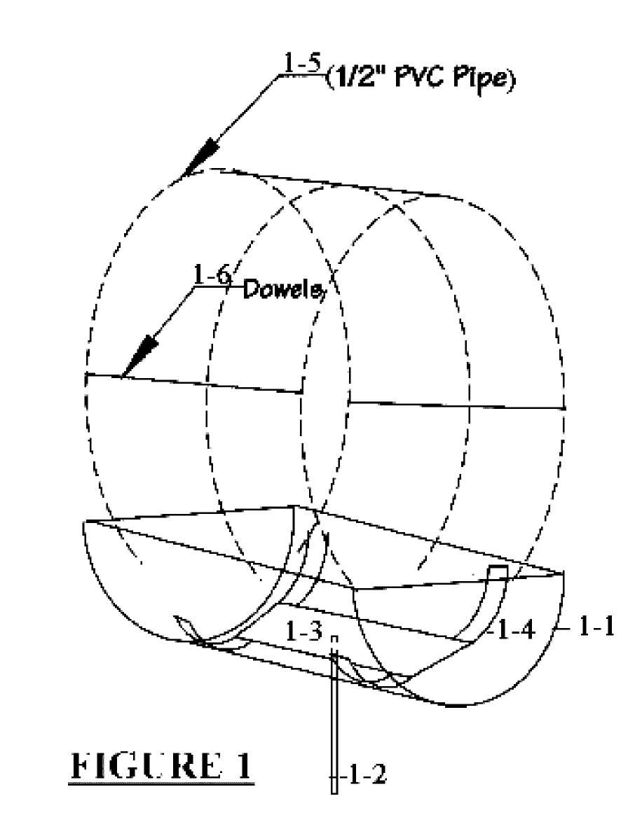

According to one preferred embodiment of the above ground gardening system disclosed herein, as shown in FIG. 1, the system includes a curved bed 1-1, into which gardening soil may be deposited.

The gardening soil is preferably a rootkake formula specially designed for high yield successive gardening through a series of growing seasons and harvests.

The bed, sometimes referred to as a container, may be constructed from half of a standard 55 gallon drum or barrel as described in more detail below. Thus, an ideal size for the bed of the preferred embodiment may be capable of holding up to 27.5 gallons of water or a nearly equivalent volume of soil. Alternatively, a still useful above ground garden system may vary in bed size from a capacity of about 16 to 32 gallons, for example, by splitting standard 32 or 64 gallon barrels.

As further depicted in FIG. 1, the above ground gardening system of the preferred embodiment includes a single rod 1-2, which might also be referred to as a pole or a stand. Rod 1-2 emanates from a center point of base 1-1 or from a cradle design to hold base 1-1 in place. Rod 1-2, designed to be singular pole or stand, may form part of the cradle configuration shown in FIG. 1, which includes main beam 1-3 and arms 1-4. Main beam 1-3 should be sufficient length and width to support base 1-1. Arms 1-4 of the cradle attach to main beam 1-3 and from this attachment point or region bend upwardly in the direction of the intended location of base 1-1. Arms 1-4 form part of the cradle support for base 1-1 and should be of sufficient length, width and strength, to prevent base 1-1 from moving or otherwise rolling out of the cradle. Rod 1-2 may permanently attached to main beam 1-3, for example by weld, or may be attachable by way of strong, secure, but non-permanent attachment, for example a threaded screw connection to a mated location on main beam 1-3. Preferably, rod 1-2 is a steel rod of at least one half inch diameter, but other materials of suitable strength and affordability may be used. Rod 1-2 should be located at the center of the main beam so that the cradle may be properly balanced. Preferably rode 1-2 is approximately 36 inches in length, so that the bottom end of rod 1-2 (that is opposite the end of rod connected to base 1-1) may be driven deeply (e.g., 18 inches) into the ground above which the above ground garden will stand. For such an in-ground installation, preferably this lower end of rod 1-2 will be sharpened or pointed to facilitate ground puncture. Alternatively, as described in more detail below, this bottom end of rod 1-2 may be connected to a stand of sufficient design, weight and construction to hold the weight of the above ground gardening system and will prevent the system from tipping over even under severe weather conditions, as should be expected for proper in-ground installations.

FIG. 1 also depicts a detachable and perfectly symmetrical curved trellis loop system that is designed for easy installation and utilization as vertical supports for climbing plants. In one embodiment, the trellis loop system includes a series of loops 1-5. Loops 1-5 may be constructed of PVC pipe/tubing or other economical, sturdy, yet partially flexible material. Preferrably loop 1-5 is constructed of PVC pipe/tubing with a diameter of about one and one half inches. Loop 1-5 attaches at one end of the loop to a point or region, or attachment thereto, along on long edge of base 1-1. Attachment of loop 1-5 to base 1-1 may be, for example, by way of nuts and bolts, such as one quart inch nuts and bolts. The other end of loop 1-5 attached to a point or region, or attachment thereto, along the other long edge of base 1-1, such a loop 1-5 bends into a symmetrical semi-circular shape and remains available as part of a trellis system for the vines of a climbing pant to be secured as the plant grows and is capable of vertical extension. As shown in FIG. 1, the trellis loop system may include a series of loops 1-5. Where a series of loops 1-5 are used, dowel rod 1-6 may be used to further secure, strengthen and stabilize the trellis loop system. Dowel rod 1-6 should generally be straight and at least semi rigid and may constructed of aluminum, or PVC pipe/tubing, or steel, or even wood, so long as rod 1-6 is constructed of a lightweight material of sufficient strength and durability to provide consistent support to the trellis loop system over time. In an exemplary embodiment, rod 1-6 is 36 inches in length, three eighths inch in diameter and is constructed of aluminum.

The trellis loop system is strong and durable because each end of the loop system is secured to the bed or an attachment thereto. Moreover, the trellis loop system does not occupy space within the soil of the garden bed nor require soil penetration or compaction in order to provide strength and support. The trellis loop system is preferably designed to be removable system.

Preferably a winter solar cap may be utilized to fully encapsulate the garden within the above ground gardening system in a flexible, transparent or translucent material that will trap solar warmth and allow for gardening beyond peak growing seasons.

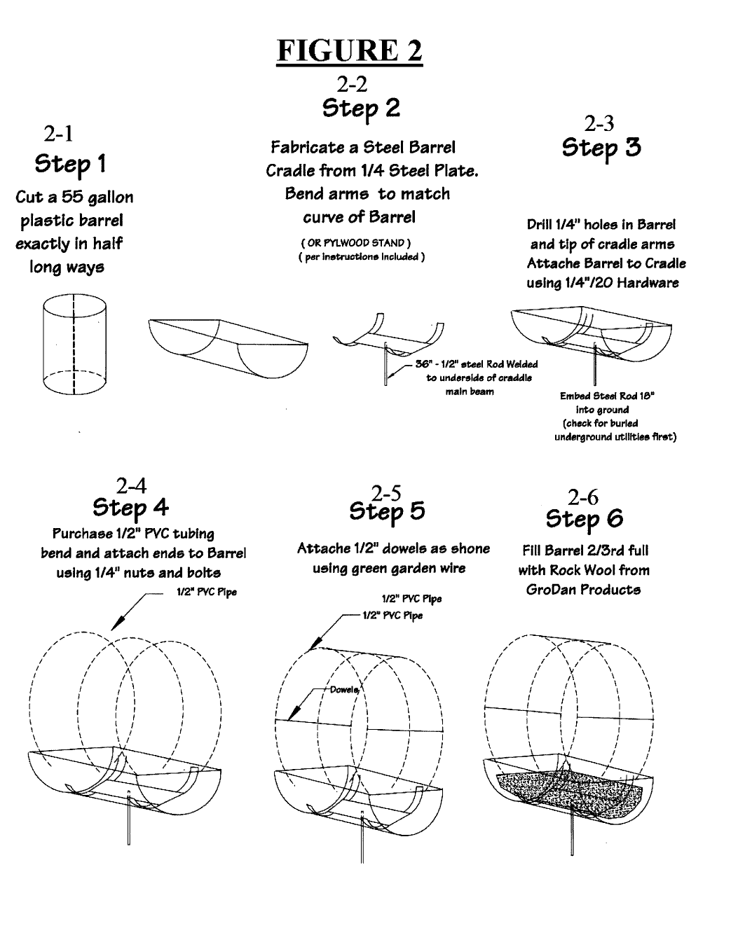

The above ground gardening system disclosed exemplified in FIG. 1 may be constructed in the following successive steps, as described in FIG. 2. First, base 1-1 is isolated. Base 1-1 maybe created, for example, by cutting a standard sized plastic barrel in half lengthwise as shown at 2-1. As noted above, half of a 55 gallon drum (or barrel) may allow for an ideal sized base 1-1 for a backyard above ground garden system. In step two (2-2), a cradle is assembled which contains one main beam 1-3, and at least a pair of extended arms 1-4 or four separate arms 1-4. Two arms 1-4 are attached to each side of the main beam 1-3. Arms 1-4 should extend outwardly from a total of four locations along main beam 1-3. Thus two arms may be used if each arm 1-4 is of sufficiently length to protrude from and provide support from either side of main beam 1-3, as show in FIGS. 1 and 2. Arms 1-4 should be attached or connected near each of the shorter ends of main beam 1-3. Arms 1-4 and main beam 1-3 should be constructed a material of sufficient strength and durability so that the cradle may provide sufficient support to hold the base, soil, and above ground garden in place over time. Main base 1-3 should be of sufficient strength to anchor arms 1-4. Main base 1-3 may be constructed, for example, of a one quarter inch thick steel plate. In the final stage of step two, the cradle is completed once rod 1-2 is secured to the center of the main beam 1-3.

In step three (2-3) of the construction of the exemplified system of FIG. 1, as shown in FIG. 2, cradle arms 1-4 are attached to base 1-1 by hardware connecting through aligned holes in arms 1-4, aligned with similarly sized holes in base 1-1. Alternatively, arms 1-4 may be designed to fit into inside of corresponding grooves or pockets along base 1-1.

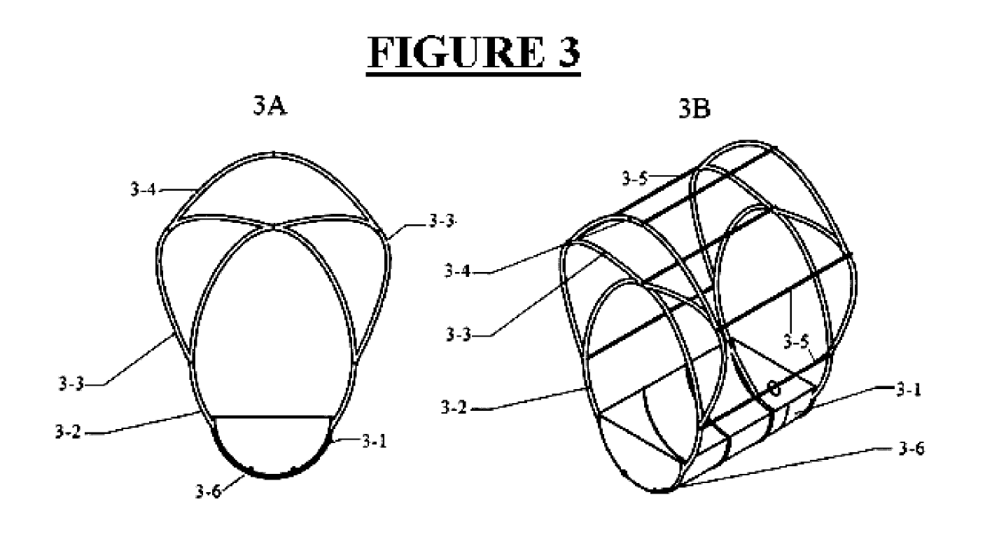

FIG. 3 depicts a trellis loop system of an exemplary embodiment of an above ground gardening system. FIG. 3A shows a frontal view of the trellis loop system. FIG. 3B shows a perspective view of the trellis loop system. Two sets of trellis loops are visible in perspective view 3B. Each set is connected to the other set of trellis loops by a total of six dowels or rods 3-5, two sets of dowels 3-5 on one side, two sets of dowels 3-5 on the other side, and two dowels 3-5 in the middle. There are three components to each set of loops in the exemplary trellis loop system shown in FIG. 3. Base loop 3-2 is the loop that connects at each of its ends directly to either side of base 3-1, along the long side of based 3-1. Base loop 1-2 forms the first and lowest loop of the trellis loop system. Two wing loops 3-3 attach to base loop 3-2, and form the outer most loops of the trellis loop system. The ends of wing loops 3-3 attach on either side of the midpoint of base loop 3-2. Cap loop 3-4 connects at each end to the midpoint of each of wing loops 3-3. Cap loop 3-4 forms the upper most loop of the trellis loop system. The first set of loops 3-2, 3-3, and 3-4 is connected near one of the shorter ends of base 3-1. A second set of loops 3-2, 3-3, and 3-4 is connected near the other one of the shorter ends of base 3-1.

Base loop 3-2 is the backbone of the trellis loop system and supports wing loops 3-3, which in turn support cap loop 3-4, which gives the trellis loop system its upper level support. In a preferred embodiment, base loops 3-2 are constructed of PVC, are approximately112 inches in length and one half inch in diameter, and are also the form over which a solar retention cap may be fitted. Thus, at least wing loops 3-3 and cap loop 3-4 should be designed to be easily detachable. Preferably the entire trellis loop system is designed for easy attachment and detachment. In a preferred embodiment, wing loops 3-3 and cap loops 3-4 are PVC of approximately 48 inches in length and one half inch in diameter. Ideally the solar retention cap is formed of a clear, stretchable or elastomeric plastic material, which is form fitted to slip over base loops 3-2 to form a solar cover to the above ground gardening system.

Base loop 3-2 is the loop around which any plant that needs to get to the top cap will be directed to grow (e.g., cantaloupe, squash, ect). Plants may be directed along loops using wire tie or similar fastener material in order to tie the plant to base loop 3-2 or lowest support rod 3-5, which may establish a direction to grow the plant. Tie wiring should be adjusted upwardly along the trellis loop system as the plant grows to continue directing the plant. Plants should be spaced to maintain proper air flow and to make the plants easy to tend, as well as to allow plenty of light to reach all of the plants. Good air flow should also prevent harmful bacteria from growing.

Returning to the construction of the FIG. 1 exemplary embodiment, as shown in FIG. 2, step four (2-4) is the attachment of the aforementioned trellis loop system. Note that the trellis loop system may be series of simple symmetrical loops as shown in the dotted lines of 2-4, or may be the success loop system described above and illustrated in FIG. 3.

Step five (2-5) as shown in FIG. 2, is the attachment of the dowels to the loops. Dowels add rigidity and stability to the trellis loop system and further provide an attachment location for directing a plant's upward growth as previously described.

Step six (2-6), is the point at which base 1-1 (or 3-1) may be filled so that gardening may commence. As suggested in step 6 of FIG. 2, a recommended starting point is to fill the base (or barrel) two thirds full with gardening starter material.

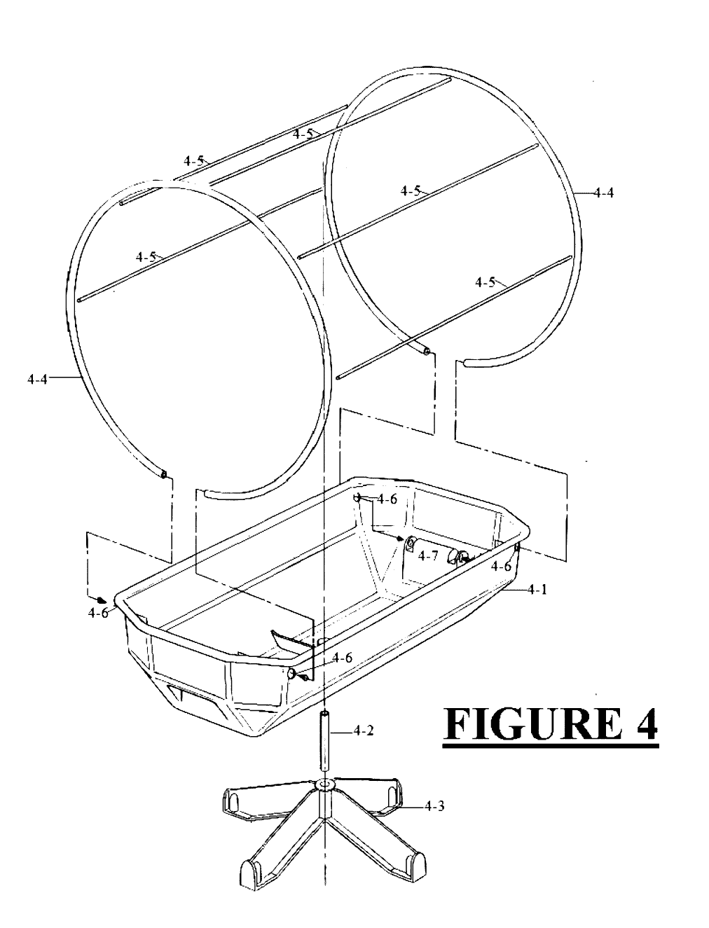

FIG. 4 depicts an alternative embodiment of an above ground gardening system. Notably, FIG. 4 includes a stand, 4-3. As noted above, this stand should be of sufficient size and configuration to prevent the above ground gardening system from tipping over even in severe weather conditions. Notably, rod 4-2 should be considerably shorter in this embodiment as a shorter rod will allow for greater stability of the overall system. The alternative system of FIG. 4 further illustrates an additional option for the shape and design of base 4-1. Base 4-1 may be angled inwardly but without the continuous, symmetrical curvature of a circular barrel or drum. This alternative design may more economical and suitable for prefabrication. Moreover, this fabrication design may allow for the inclusion of pre-fabricated features such as handle indentations and a loop attachment mechanism. Base 4-1 may also be pre-drilled with four holes 4-6 at each end of base 4-1. Holes 4-6 are intended to be the locations through which the pair of loops 4-4 are inserted through base 4-1. Once inserted through holes 4-6 in based 4-1, loops 4-4 may be attached to loop attachment mechanism 4-7 to secure loops 4-4 and prevent unintentional detachment from based 4-1. Dowels 4-5 attach at either end to each pair of loops 4-4. In FIG. 4, five dowels 4-6 connected two loops 4-4 are shown for the entire trellis loop system.

Under a preferred embodiment, rod 1-2 may be constructed of steel and of a diameter of one half inch and length of 36 inches. Preferably rod 1-2 is installed 16 to 18 inches into the ground, assuming plumb installation. The other end of rod 1-2 can be insert into the opening in bottom center of the cradle or directly into the bed (i.e, trough) if a cradle-less design. In a preferred embodiment rod 1-2 lifts the garden bed surface to approximately 34 inches above ground, bringing the surface just below waist high for the average American adult. The use of a single mechanical anti-gravitational device (e.g., steel rod) may also be designed to allow the complete garden to pivot on rod 1-2 and therefore rotate a full 360 degrees. This rotational feature will allow the garden to be tended from one spot. The ability to rotate also gives the gardener more control of sunlight distribution.

The single rod design also allows for the above ground garden system to be installed on a lawn, and allow for grass to be easily cut and weeds trimmed around the rod. Bed 1-1 is ideally constructed of a sturdy yet lightweight material, such as a polymeric material like high density polyethylene (HDPE) or polyvinyl chloride (PVC) or other sturdy lightweight plastic. In an exemplary embodiment, bed 1-1 (aka trough) is ideally of a size that is approximately 36 inches in length, 24 inches in width, and 18 inches in diameter. Bed 1-1 ideally includes four drainage holes of approximately three-eighths of an inch in diameter, with the holes evenly spaced at bottom of container to allow excess water to drain out, thus preventing overwatering, stagnation, root rot and damage to surface, vines, stalks/trunks. As noted above, bed 1-1 may rest on a cradle with main beam 1-3 and arms 1-4, or alternatively may rests directly on the top of rod 1-2. For in-ground installation rod 1-2 may be tapered, or an alternative to ground installation, as shown in FIG. 4 and disclosed above, rod 4-2 may be installed into a base stand capable of receiving and securing rod 4-2 so that it remains plumb, and allows for bed 4-1 to remain balanced and rotatable in a horizontal plan. Utilization of a base stand that will allow the system to be located on a porch or other surfaces other than the ground, into which penetration with rod 1-2 may not be an option. Consideration must be given to the length of rod 4-2 and the weight of stand 4-3 so that the system remains stable and resistant to toppling.

The symmetrical, tri-level design trellis, as depicted in FIG. 3, provides the gardener perfect strength and design assistance for pruning and arraigning plants. The shape of the trellis is designed for function and strength. It performs perfectly in both of those areas Providing multiple points of adequate support for spreading out the foliage allows the gardener the opportunity to keep the foliage properly managed. The symmetrical, tri-level trellis shape and size, as exemplified in FIG. 3, is also designed for the ease and comfort of the user, from young children to the elderly. This tri-level trellis design also allows for greater airflow through the entire garden helping to eliminate moisture related disease.

The rootkake (the root housing matter) is designed to provide the physical structure and volume to properly house, water and feed the entire root systems of all of the plants throughout their life cycles. Four important elements to promoting a healthy root system are: (i) proper moisture retention, (ii) proper nutrients, (iii) good aeration, and (iv) adequate volume. The ideal rootkake is designed to satisfy each of these elements. The rootkake has a bottom layer of rockwool, a horticultural growing media made from inert basalt (lava) rock and chalk. Rockwool, may be, for example, Grodan of 10 inch width by 4 inch thickness. A rockwool base retains moisture for the tap roots. The organic layer of the rootkake is 64 dry quarts of light weight potting soil (any brand). The potting soil, supplemented as described below, will provide a friable, loamy form of root environment perfect for proper aeration and moisture retention. Note that plant roots do not actually grow in soil, but rather the air spaces between soil particles.

There are three basic types of soil, sandy (drains quickly), clayey (drains slowly), and loamy. Loamy soil has the perfect structure because it has just the right amount of organic material to absorb and retain moisture while still allowing the excess moisture to drain out of the soil allowing air movement thus removing the carbon dioxide given off by the roots and allowing oxygen to flush through for new growth.

The preferred soil supplement includes the following: a mixture in the top 6 inches (of potting soil) consisting of minerals and trace minerals in 3 micronized sizes, designed to provide mineral rich nutrition to the plants starting day one. Simply supplying water will activate the soil supplement. The first stage (i.e., first supplement) release starts day one and lasts four months. The second stage (slightly larger size and portion of supplement) starts to release around the third month and continues to release for five months. The third and final stage (larger still) of the supplement starts to release around the seventh month and lasts to the end of one full year. The breakdown and release of the nutrients are timed to be available to the plant roots in the quantity matching the need and capacity of the root systems to consume them.

It is further recommended to utilize a nitrogen, phosphorous, potassium monthly booster (NPK booseer) that is separate from the soil supplement. Hand-watering requires a monthly application. The NPK booster is released at each watering with systems that use the automatic watering systems.

Preferred soil conditions also include pH. pH levels for a typical summer garden is 6.5. The rootkake preferably starts at 6.5 pH. By supplying small amounts of pH adjuster, including for example, sulfur and calcitic lime or dolomite, the garden can maintain proper pH levels, which might otherwise be impacted by acid rain. Moreover, different plants have different PH requirements that may be addressed by a pH adjuster.

An additional embodiment includes a solar retention cap and heat wire, included for cool and cold weather crops. The solar cap may be constructed of a 6 mil clear plastic that is shaped to fit over the base trellis 3-2 and secured with a fastener or elastomeric cord, such as a bungee cord or alternative tightening solution (like a shower cap). The result is ideally an inside vertical growing space of approx. 8 cubic feet in volume. The solar retention cap along with heating element in the rootkake creates a slightly warmer, friendlier environment for cool and cold weather plants to thrive.

In the additional embodiment, the heat wire is thermostatically controlled and placed 2 inches above the rockwoold (e.g. Gordan) slab, to a depth of about 12 inches within the potting soil. The heat wire may be powered by AC or DC electric current. A battery may be recharged by a solar collector which sits above the solar retention cap.

In a preferred embodiment there may a watering hose used with an automatic watering system. The hose may include, for example a fitting of three-quarters of one inch in diameter and contain an in line cylinder containing the NPK booster. In combination with the cyclinder, the hose may be connected to a water filter that may be, for example one-eighth of one inch in diameter. The hose runs to the first system, up into the rootkake where it is coiled around 2 to 3 inches below the surface. All watering is done sub-surface. For a system using a main watering line to work in tandem a three way plastic ribbed connection may be utilized which allows the line to continue to the next system. For gardens with automatic watering systems the NPK booster may also be automatic, with an NPK booster cylinder containing the NPK supplement and the water filter are inline.

While the foregoing invention has been described in some detail for purposes of clarity and understanding, it will be appreciated by one skilled in the art from a reading of this disclosure that various changes in form and detail can be made without departing from the true scope of the invention and appended claims. All patents and publications cited herein are entirely incorporated herein by reference.

The invention claims is:

1. An above ground gardening system comprising,
a singular rod extending upwardly and connected to the bottom of a gardening bed at its midpoint;
the gardening bed comprising (i) a half-barrel shaped trough wherein the longer sides of the bed slope downwardly toward the bottom of the bed and the shorter sides are generally not sloped relative to a vertical plane, and (ii) a support structure for connecting the rod to the sloped walls of the bed so that the bed is supported, balanced and permitted to move rotationally along the axis of the rod;
a trellis loop system, wherein (i) each short side of the bed has attached to it a base trellis loop that connects to the two corners on each short side to form a egg-shaped base loop, (ii) each base loop has attached to it a pair of winged trellis loops that meet and connect at the uppermost point of the base loop; (iii) each pair of winged loops is connected from their midpoints to a cap loop that extends upward above the winged loops, so that the trellis loop system forms four circumferential holes or open spaces with the loop structure at each short side of the base.

2. The above ground gardening system of claim 1, wherein the winged and cap loops are detachable and may be removed and replaced by a form-fitting, plastic solar retention cap.

3. The above ground gardening system of claim 1, wherein a heating element and an automatic watering system are incorporated into the system, with the watering system including an inline water filter and a container of nitrogen, phosphorus and potassium booster for automatically boosting soil mineral concentrations.

4. The above ground gardening system of claim 1, where the singular rod is tapered on one end to allow the rod to be driven into a ground surface.

5. The above ground gardening system of claim 1, wherein the singular rod is inserted into a base stand, and wherein the rod and stand are configured to keep the gardening bed balanced when filled with soil.
